(19) United States
(12) Patent Application Publication
(10) Pub. No.: US 2025/0253933 A1
(43) Pub. Date: Aug. 7, 2025

(54) IDENTIFYING AN ARTIFICIAL SATELLITE

(71) Applicant: Wells Fargo Bank, N.A., San Francisco, CA (US)

(72) Inventors: Peter Burton Bordow, Fountain Hills, AZ (US); David Marc Delfiner, Charlotte, NC (US); Michael Erik Meinholz, Charoltte, NC (US); Abjijit Rao, Irvine, CA (US); Bradford A. Shea, Mint Hill, NC (US); Jeff J. Stapleton, O'Fallon, MO (US); Richard Toohey, Burlington, VT (US)

(21) Appl. No.: 18/431,379

(22) Filed: Feb. 2, 2024

(51) Int. Cl. H04B 7/185

(52) U.S. Cl. CPC H04B 7/18519; H04B 7/18513

(57) ABSTRACT

System and techniques to distinguish an artificial satellite from another object are described herein. A physical measurement is gathered of a candidate object for a known satellite in an orbit. This physical measurement is compared to a corresponding known value for the known satellite traveling in the orbit. Based on this comparison, a score is created, the score being a representation of certainty as to whether the candidate object is the known satellite. The score is used to modify a planned communication with the known satellite.

### TECHNICAL FIELD

Embodiments described herein generally relate to physical communication security and more specifically to identifying an artificial satellite.

### BACKGROUND

An artificial satellite is a human-made object deliberately placed into orbit around celestial bodies, such as Earth, to serve various scientific, technological, or communication purposes. Artificial satellites are generally launched into space via rockets and positioned into one of several possible orbits. Earth orbits generally are either geostationary—where the artificial satellite remains over a fixed point—or non-geostationary. Non-geostationary orbits can include low Earth orbit (LEO), medium Earth orbit (MEO), and highly elliptical orbit (HEO). Artificial satellite positioning usually uses principles of orbital mechanics to ensure that the artificial satellite maintains trajectory and altitude. Artificial satellites often include thrusters to make minor adjustments to maintain an orbit, to change orbits, or to deorbit at the end of operational life.

Artificial satellites are often equipped with systems for power generation (e.g., solar panels), communication mechanisms (e.g., antennas, transponders, etc.), and computers for control or data processing. Artificial satellites are often used in communications, weather forecasting, navigation systems—such as the Global Positioning System (GPS)—astronomical observations, or Earth observation. Earth observation may include such activities as environmental monitoring or scientific research.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system for identifying an artificial satellite, according to an embodiment.

FIG. 2 illustrates several examples of orbital variation for an artificial satellite, according to an embodiment.

FIG. 3. Illustrates several examples of identifying characteristics of an artificial satellite, according to an embodiment.

FIG. 4 illustrates a flow diagram of an example of a method for identifying an artificial satellite, according to an embodiment.

FIG. 5 is a block diagram illustrating an example of a machine upon which one or more embodiments may be implemented.

### DETAILED DESCRIPTION

Communications often include information that is sensitive or confidential, and thus steps are taken to ensure that such information is protected from parties not authorized to receive the communication. In some wired networks, physical security of the communications lines and terminals can be sufficient. However, in wireless and free space networks, or wired networks that traverse third party controlled sections of the networks, such physical security is often impossible. Thus, a variety of cryptography techniques are usually used to protect sensitive or confidential data.

The recent emergence of actual quantum computers and the potential for more advanced quantum computers raises doubts on the reliance of some cryptography alone to secure communications. For example, the widely used RSA public-key cryptography relies on the difficulty in factoring large numbers into their component primes. Shor's algorithm is a quantum computer technique is believed to be able to factor such large numbers exponentially faster than is possible on classical computers. Although work is progressing on developing post-quantum cryptography algorithms, a very real issue is raised by these advanced computing systems and the ability of people to keep their data protected.

To address the issues above, a participant (e.g., sender or receiver) of a communication can be identified via physical characteristics to establish a level of trust to apply to the participant in a communication. The measurement of these characteristics and evaluation of similarity to known values for the intended recipient can be used to control not only how the communication is protected in transit, but whether the communication is sent at all. In the context of low-Earth-orbit (LEO) satellite recipients, such physical characteristics can be analogized to the biometrics of a person. These LEO-metrics can include known variations in the orbit (e.g., wobble), reflectivity of the sun off of parts of the satellite, land-based or space-based objects visible from the satellite, or internal operating parameters (e.g., battery voltage, solar array collection, etc.).

In preparation for a planned communication with a known satellite, metrics can be collected and these measurements can be compared against known values for the satellite. If the collected measurements vary from the known values, additional security measures can be taken because the greater the variance, the less likely that the object being observed is the known satellite. When the probability that the observed object is the known satellite is low enough (e.g., lower than a predetermined threshold), the communication is not made, ensuring that the data remains secure. Additional details and examples are provided below.

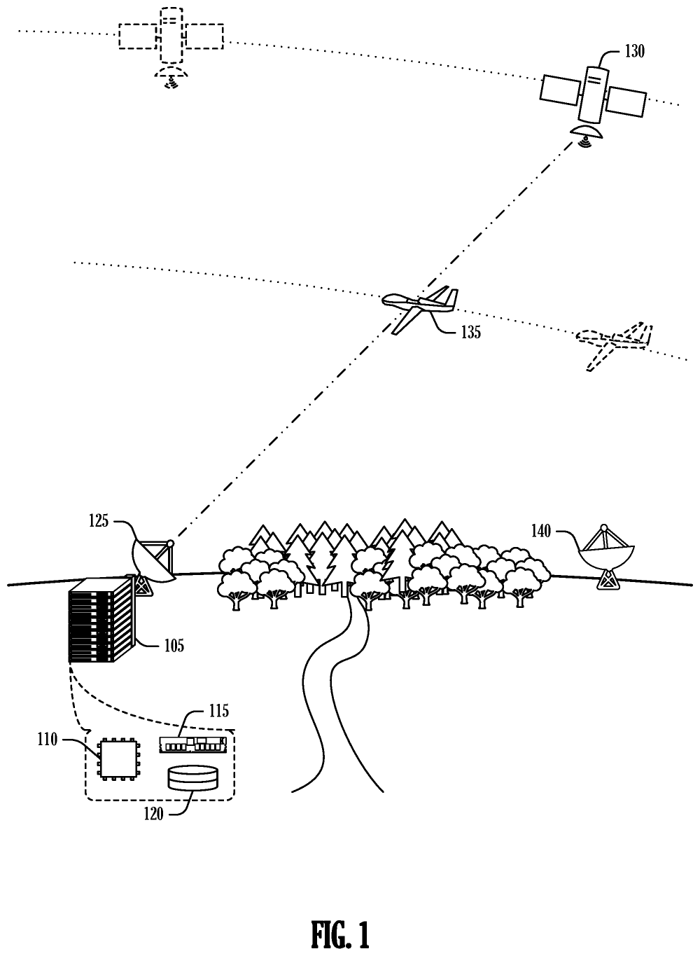

FIG. 1 is a block diagram of an example of an environment including a system 105 for identifying an artificial satellite 130, according to an embodiment. As illustrated, the system 105 includes processing circuitry 110 (e.g., a processor, graphics processing unit (GPU), etc.), working memory 115 (e.g., volatile or non-volatile random access memory (RAM)), and storage 120 (e.g., non-volatile solid state storage, hard drive, optical drive, etc.). The working memory 115 is configured to hold state information of the system 105 while in operation and is usually reset (e.g., cleared) when power is interrupted or the system 105 is reset (e.g., rebooted). The storage 120 is configured to persist data or instructions between such power or reset events. The working memory 115 or the storage 120 can include (e.g., store) instructions that, when the processing circuitry 110 is operating, configure the processing circuitry to perform a variety of functions.

The system 105 can include or have an interface to couple to (e.g., control, send or receive commands, etc.) a transceiver 125 configured to communicate with a recipient object, such as the satellite 130. In an example, the transceiver 125 is configured to communicate using photons in one or more frequencies or configurations. For example, the transceiver 125 can operate in radio frequencies. In an example, the transceiver 125 includes multiple antennas to perform beamforming to direct a transmitted or received signal. In an example, the transceiver 125 uses light. In an example, the transceiver 125 uses coherent focused light (e.g., a laser) to produce a beam for transmission.

The system 105 can also include, or have an interface to couple to, other sensors, such as the radar 140. These sensors are configured to make observations of, for example, the satellite 130 or the aircraft 135. Example observations, and thus measurements, can include position, visual information (e.g., an image), reflectivity, etc.

The illustrated scenario involves an intended communication to the satellite 130 and an attempted interception of the communication by another entity, the aircraft 135. The following describes a technique to identify a candidate for the communication as the satellite and reject a communication to the aircraft 135 (e.g., a counterfeit satellite, imposter satellite, or other object posing as a satellite whether or not the object is an actual artificial satellite). In a variety of equivalent scenarios, the aircraft 135 can be another satellite, a balloon, or any other object capable of intercepting a communication intended for the satellite 130.

In the illustrated context, to identify the artificial satellite 130—or to identify that the aircraft 135 or other counterfeit satellite is not the known satellite 130—the processing circuitry 110 is configured to identify a candidate object for a known satellite. The identification may be initially made by the radar 140 or by another observation. Consider, for example, that a communication is planned for the satellite 130 at a certain time. The processing circuitry 110 is configured to search for the satellite 130 at a known position but, instead, identifies the aircraft 135 because the aircraft 135 is interposed between the transceiver 125 and the satellite 130. In this scenario, the aircraft 135 is the candidate object. However, if there is nothing interposing the transceiver 125 and the satellite 130, then the satellite is the candidate object.

In an example, the system 105 is a ground-based device, as illustrated. However, other operational positions can be used. For example, the system 105 can be housed in a balloon, aircraft, or another satellite. In an example, the candidate object is in orbit (e.g., around the Earth).

The processing circuitry 110 is configured to obtain a physical measurement of the candidate object. The physical measurement is a measurement of some physical characteristic of the candidate object. Such measurements can be externally observed, such as by the previously mentioned sensors, or can be internally observed and provided by the candidate object. Due to the energy used to put objects into orbit, on-board fuel to adjust satellite orbital positions is often limited. Accordingly, satellite orbits tend to exhibit remarkable consistency. However, due to the myriad of forces operating on orbital objects, the orbits can develop a variety of small and often recurrent variations that can be used to identify satellites nearly uniquely, like fingerprints or walking gaits in humans.

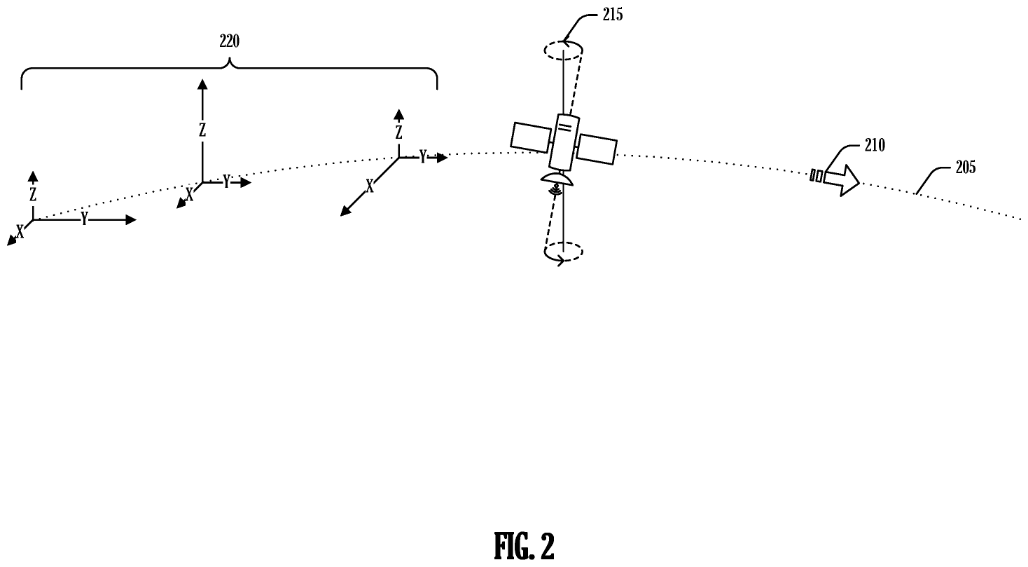

Thus, in an example, the physical measurement is based on the orbit of the candidate object. In an example, the physical measurement is orbital wobble. In this context, orbital wobble refers to slight, irregular movements or variations in an orbit. This phenomenon can be caused by various factors, such as gravitational influences from other celestial bodies, non-uniformity of a planet's gravitational field, atmospheric drag, solar radiation pressure, or satellite operational activities such as thruster firings. These perturbations can cause a satellite to deviate from its intended orbit, leading to changes in its altitude, inclination, or position along its orbit. Due to the unique forces acting on the satellite 130, such wobble can be difficult for the aircraft 135 to simulate. Examples of orbital wobble are illustrated in FIG. 2.

In an example, the physical measurement is based on timing light from a ground-based emitter to the known satellite, and back to a ground-based detector. The radar 140, or a laser-based range finder can perform this measurement. Because the speed of the photons is essentially fixed and constant in the atmosphere, measuring the time between an identifiable emission and a reflection off of the candidate object of that emission can provide accurate measurements of the distance of the candidate object from a detector. Thus, it can be possible to determine that, for example, the aircraft 135 is too close to the Earth to be in orbit or, more precisely, to be the known satellite (e.g., the satellite 130).

In an example, the physical measurement is based on a solar collector of the candidate known satellite. Here, the satellite 130 has a solar collector to, for example, provide power to the satellite 130. Such collectors often have characteristics that are observable from the ground (e.g., reflectivity) or measurable from the satellite 130 (e.g., how much power is being produced) that help to uniquely identify the satellite 130. Accordingly, in an example, the physical measurement is a reflectivity of the solar collector that is observed from the ground-based device. In an example, the physical measurement is energy capture of the solar collector. Both of these features can vary based on determinable positions of the satellite 130, the sun, the moon, or other objects. Accordingly, a reading can not only be nearly unique to the satellite 130, but also to the orbital position of the satellite 130.

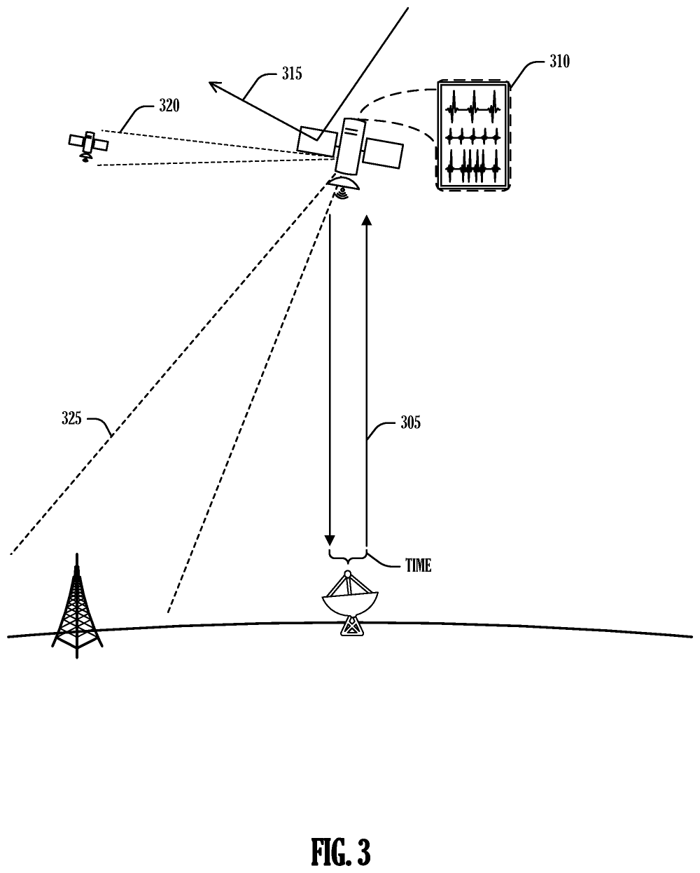

As noted below, the energy capture of the solar collector is measured by the satellite 130 and thus is communicated to the system 105 for this measurement to be obtained by the system 105. Other such measurements, made by the satellite 130 and communicated to the system 105, can include observations of ground-based landmarks (e.g., buildings, rivers, etc.), celestial observations (e.g., other satellites, stars, etc., or other internal measurements (e.g., current draw of electronics, heat generation, temperature, etc.). Examples are illustrated in FIG. 3. These internal measurements can be communicated to the system 105 in a variety of ways. For example, a scheduled report of internal operations may be maintained between the satellite 130 and the system 105. In an example, the system 105 engages in a communication handshake in which the data is delivered to the system. In an example, the initiation of the communication handshake by the candidate object serves to identify the candidate object to the system 105.

The processing circuitry 110 is configured to compare the physical measurement to a corresponding known value—of the known satellite—to generate a certainty score for whether the candidate object is the known satellite. The certainty score can be based on probability, the output of an artificial intelligence classifier, or other techniques that accept the physical measurement and the corresponding known value as inputs and produces a score as an output. For example, if the physical measurement is identical to the known value, the certainty score can be a one. If, however, the comparison between the physical measurement and the known value differ by thirty percent, then the certainty score can be 0.7. However, depending on the physical measurement, the certainty score can be non-liner. For example, a deviation between the physical measurement and the known value within a margin of error can elicit a certainty score of 0.95 that drops exponentially as the variance exceeds the margin of error.

The known values are specific to the known satellite and are collected from manufacturing measurements (e.g., a particular energy draw of a processor), launch telematics (e.g., a particular variance to the orbit due to launch variations), recurrent observations (e.g., a stable wobble has been observed for two years), etc. In general, the known values are, to the extent possible, a catalogue of the physical characteristics possessed by the satellite 130. Accordingly, if the physical measurements of the candidate object do not match the known values, it is unlikely that the candidate object is the known satellite.

In an example, where the candidate object has provided energy capture of a solar collector as a physical measurement, the corresponding known value is a pattern of energy collection over time. In an example, the value provided by the candidate object includes several samples such that the value can be compared to the pattern of energy collection overtime. Several of the known values can change in predictable ways over time. These can include periodic changes, or trending changes, such as a degradation in battery performance. Tracking the changes over time can enable a more precise matching with the physical measurements taken during this identification.

The processing circuitry 110 is configured to modify a planned communication with the known satellite based on the certainty score. For example, the system 105 can abort or refrain from the planned communication when the candidate object is probably not the known satellite (e.g., the certainty score is below a predetermined threshold). However, variances in the ability to measure physical characteristics, imprecision in previous measurements, or other sources of error can result in difficulty in being certain enough to interrupt a planned communication. In these examples, the certainty score can be used to select one or several modifications. Generally, the less certain that the candidate object is the known satellite, the stricter (e.g., onerous, costly, etc.) the security measure used to modify the planned communication. Examples of stricter security measures can include using a different transmission technique (e.g., using a narrow beam laser rather than a beam-formed radio frequency signal), adding encryption (e.g., post-quantum encryption), spreading out the communication (e.g., making it harder for the interloper to mimic the known satellite) etc.

In an example, the processing circuitry 110 is configured to obtain a set of physical measurements of the candidate object and compare the set to corresponding known values. Here, several possible physical measurements are made and compared increasing the difficulty for the aircraft 135, for example, to counterfeit the physical measurements. In an example, the certainty score is based on results of comparing the set of physical measurements to the set of corresponding known values. The individual physical measurements can be treated equally or weighted, for example, giving greater impact (e.g., greater weight) to physical measurements that are more difficult to fake. By observing the physical characteristics of the candidate object, and comparing these observations with known values, the system 105 can take steps to ensure that data is secured even when present encryption techniques fail in this task.

FIG. 2 illustrates several examples of orbital variation for an artificial satellite, according to an embodiment. The illustrated satellite is proceeding on the orbit 205. While traversing the orbit 205, several variations in the orbit 205 can occur. For example, the satellite can deviate from the orbit 205 via a translation 220 (e.g., a movement in the Cartesian x, y, or z direction). The translation 220 can be periodic (e.g., oscillating), progressive (e.g., a slow steady decrease in z, such as a decaying orbit), and set (e.g., a slightly higher than planned orbit).

While a periodic form of the translation 220 can be considered a form or aspect of orbital wobble, a rotational variation 215 can also be a form or aspect of orbital wobble. The rotational variation 215 refers to a periodic change in satellite orientation while the satellite travels the orbit 205. As illustrated, the rotational variation 215 is a clockwise motion of the satellite about its center of mass.

Another orbital variation is a change in velocity 210. The change in velocity 210 can be in either direction along the orbit 205. In an example, the change in velocity 210 is periodic.

FIG. 3 illustrates several examples of identifying characteristics of an artificial satellite, according to an embodiment. While FIG. 2 illustrated examples of orbital variations that can be used to identify an artificial satellite, FIG. 3 illustrates examples of non-orbital measurements than can be used to identify an artificial satellite. While these are called “non-orbital measurements” to distinguish from the directional and velocity measurements related to FIG. 2, the measurements of FIG. 3 still relate to an orbit of the satellite because they are based on the conditions experienced by the known satellite in that orbit. For example, as mentioned in FIG. 1, a distance measurement 305 based on the time it takes light to be transmitted and reflected off of the satellite can be used. Because the speed of light is not generally thought to be manipulable by an interloper, this technique may be difficult to fool by a low-flying interception device. However, some techniques, such as block the reflection and transmitting a simulated reflection at an appropriate later time may work.

The reflectivity 315 of the satellite, or parts thereof (e.g., a solar collector) can be measured. Here, the generally static nature of space or the upper atmosphere results in a consistent refection of the sun off of objects given the same position of the sun and the objects. Thus, the way the sun light reflects from these objects can be a useful identifying physical characteristic of the satellite.

Similarly, the power generated by the solar collector can be used to identify the satellite. This, along with other measurements, can be grouped into internal measurements 310. Other examples of internal measurements 310 can include power consumption of on-board components, temperature of an internal components, inertial sensor measurements, etc.

The satellite can also perform external measurements. For example, the satellite can ground-sense 325—that is, sense (e.g., image, use radar, etc.) a ground-based landmark—from a unique perspective. If this perspective has previously been calculated or provided, the ground-sense 325 can be compared to identify the satellite.

Space-sense 320—the observation of a space-based object such as another satellite, celestial body, etc. —can also be used to identify the satellite. As with ground-sense 325, previously reported observations from the satellite, or pre-calculated relationships between the satellite and the space-based objects, can be used as a basis of comparison and thus identification by the space-sense 320 observations.

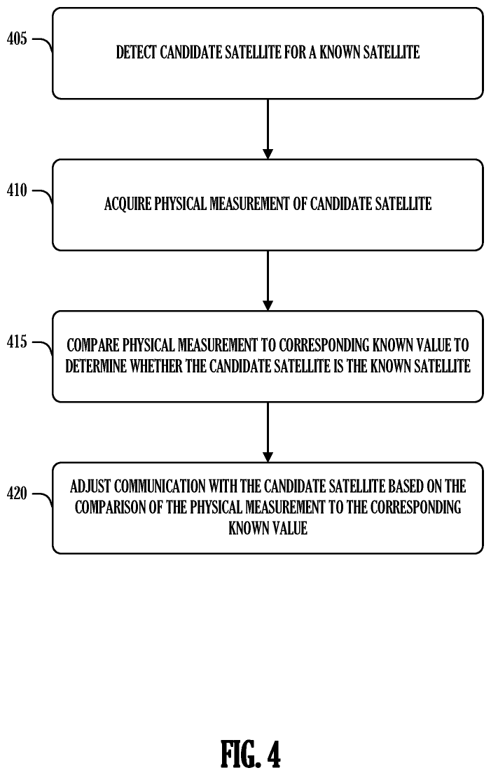

FIG. 4 illustrates a flow diagram of an example of a method 400 for identifying an artificial satellite, according to an embodiment. The operations of the method 400 are performed by computational hardware, such as that described above or below (e.g., processing circuitry).

At operation 405, a candidate object for a known satellite is identified. In an example, this operation can be performed by a ground-based device. In an example, the candidate object in an orbit.

At operation 410, a physical measurement of the candidate object is obtained. In an example, the physical measurement is based on the orbit of the candidate object. In an example, the physical measurement is orbital wobble. In an example, the physical measurement is based on timing light from a ground-based emitter to the known satellite, and back to a ground-based detector.

In an example, the physical measurement is based on a solar collector of the known satellite. In an example, the physical measurement is a reflectivity of the solar collector that is observed from the ground-based device. In an example, the physical measurement is energy capture of the solar collector.

At operation 415, the physical measurement is compared to a corresponding known value to determine that the candidate object is probably not the known satellite. In an example, where the candidate object has provided energy capture of a solar collector as a physical measurement, the corresponding known value is a pattern of energy collection over time.

At operation 420, a planned communication with the known satellite is modified based on the candidate object probably not being the known satellite. In an example, the candidate object provides energy capture of a solar collector as a value to a ground-based device in a handshaking procedure for the planned communication. In an example, where the known value is a pattern of energy signatures, the value provided by the candidate object includes several samples such that the value can be compared to the pattern of energy collection overtime.

In an example, the method 400 can be extended to include the operations of obtaining a set of physical measurements of the candidate object in addition to the physical measurement and comparing the set of physical measurements to a set of corresponding known values. In an example, the method 400 can also include the operations of creating a certainty score based on results of comparing the set of physical measurements to the set of corresponding known values. In an example, modifying the planned communication with the known satellite includes applying a change based on the certainty score. In an example, the change is a security measure. In this example, the security measure is more restrictive in response to the certainty level being lower.

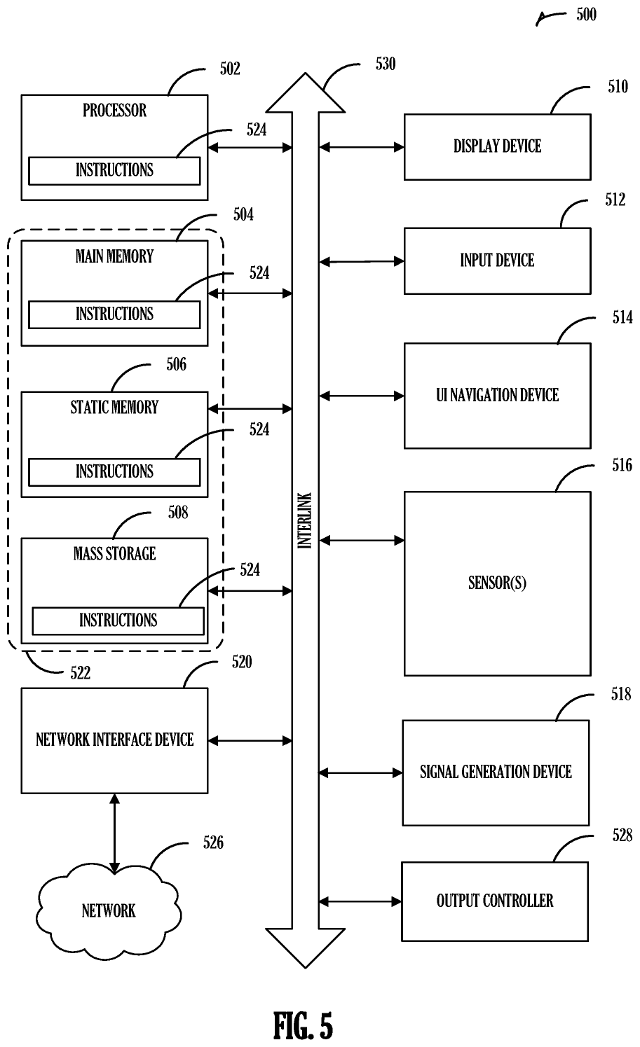

FIG. 5 illustrates a block diagram of an example machine 500 upon which any one or more of the techniques (e.g., methodologies) discussed herein may perform. Examples, as described herein, may include, or may operate by, logic or a number of components, or mechanisms in the machine 500. Circuitry (e.g., processing circuitry) is a collection of circuits implemented in tangible entities of the machine 500 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 500 follow.

In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 500 may include a hardware processor 502 (e.g., a central processing unit (CPU), a graphics processing unit (GPU), a hardware processor core, or any combination thereof), a main memory 504, a static memory (e.g., memory or storage for firmware, microcode, a basic-input-output (BIOS), unified extensible firmware interface (UEFI), etc.) 506, and mass storage 508 (e.g., hard drives, tape drives, flash storage, or other block devices) some or all of which may communicate with each other via an interlink (e.g., bus) 530. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 508, a signal generation device 518 (e.g., a speaker), a network interface device 520, and one or more sensors 516, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 502, the main memory 504, the static memory 506, or the mass storage 508 may be, or include, a machine readable medium 522 on which is stored one or more sets of data structures or instructions 524 (e.g., software) embodying or utilized by any one or more of the techniques or functions described herein. The instructions 524 may also reside, completely or at least partially, within any of registers of the processor 502, the main memory 504, the static memory 506, or the mass storage 508 during execution thereof by the machine 500. In an example, one or any combination of the hardware processor 502, the main memory 504, the static memory 506, or the mass storage 508 may constitute the machine readable media 522. While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In an example, information stored or otherwise provided on the machine readable medium 522 may be representative of the instructions 524, such as instructions 524 themselves or a format from which the instructions 524 may be derived. This format from which the instructions 524 may be derived may include source code, encoded instructions (e.g., in compressed or encrypted form), packaged instructions (e.g., split into multiple packages), or the like. The information representative of the instructions 524 in the machine readable medium 522 may be processed by processing circuitry into the instructions to implement any of the operations discussed herein. For example, deriving the instructions 524 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 may include assembly, compilation, or interpretation of the information (e.g., by the processing circuitry) to create the instructions 524 from some intermediate or preprocessed format provided by the machine readable medium 522. The information, when provided in multiple parts, may be combined, unpacked, and modified to create the instructions 524. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 524 may be further transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 802.11 family of standards known as Wi-Fi®, IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software. A transmission medium is a machine readable medium.

### ADDITIONAL NOTES & EXAMPLES

Example 1 is an apparatus for identifying an artificial satellite, the apparatus comprising: memory including instructions; and processing circuitry that, when in operation, is configured by the instructions to: identify a candidate object for a known satellite, the known satellite in an orbit; obtain a physical measurement of the candidate object that is based on the orbit; compare the physical measurement to a corresponding known value to generate a certainty score for whether the candidate object is the known satellite; and modify a planned communication with the known satellite by a ground-based device based on the probability score, wherein the apparatus is included in a ground-based device.

In Example 2, the subject matter of Example 1, wherein the physical measurement is an orbital wobble of the candidate object.

In Example 3, the subject matter of any of Examples 1-2, wherein the physical measurement is based on a solar collector of the known satellite.

In Example 4, the subject matter of Example 3, wherein the physical measurement is a reflectivity of the solar collector that is observed from the ground-based device.

In Example 5, the subject matter of any of Examples 3-4, wherein the physical measurement is energy capture of the solar collector, the candidate object providing the energy capture as a value to the ground-based device in a handshaking procedure for the planned communication.

In Example 6, the subject matter of Example 5, wherein the corresponding known value is a pattern of energy collection over time, and wherein the value provided by the candidate object includes several samples such that the value can be compared to the pattern of energy collection overtime.

In Example 7, the subject matter of any of Examples 1-6, wherein the physical measurement is based on timing light from a ground-based emitter of the ground-based device to the known satellite, and back to a ground-based detector of the ground-based device.

In Example 8, the subject matter of any of Examples 1-7, wherein the processing circuitry is configured to: obtain a set of physical measurements of the candidate object in addition to the physical measurement; and compare the set of physical measurements to a set of corresponding known values.

In Example 9, the subject matter of Example 8, wherein the probability score is a composite score created based on results of comparing the set of physical measurements to the set of corresponding known values.

In Example 10, the subject matter of Example 9, wherein, to modify the planned communication with the known satellite, the processing circuitry is configured to apply a change based on the certainty score.

In Example 11, the subject matter of Example 10, wherein the change is a security measure, the security measure being more restrictive in response to the certainty score being lower.

Example 12 is a method for identifying an artificial satellite, the method comprising: identifying, by a ground-based device, a candidate object for a known satellite, the known satellite in an orbit; obtaining a physical measurement of the candidate object that is based on the orbit; comparing the physical measurement to a corresponding known value to generate a certainty score for whether the candidate object is the known satellite; and modifying a planned communication with the known satellite by the ground-based device based on the probability score.

In Example 13, the subject matter of Example 12, wherein the physical measurement is an orbital wobble of the candidate object.

In Example 14, the subject matter of any of Examples 12-13, wherein the physical measurement is based on a solar collector of the known satellite.

In Example 15, the subject matter of Example 14, wherein the physical measurement is a reflectivity of the solar collector that is observed from the ground-based device.

In Example 16, the subject matter of any of Examples 14-15, wherein the physical measurement is energy capture of the solar collector, the candidate object providing the energy capture as a value to the ground-based device in a handshaking procedure for the planned communication.

In Example 17, the subject matter of Example 16, wherein the corresponding known value is a pattern of energy collection over time, and wherein the value provided by the candidate object includes several samples such that the value can be compared to the pattern of energy collection overtime.

In Example 18, the subject matter of any of Examples 12-17, wherein the physical measurement is based on timing light from a ground-based emitter of the ground-based device to the known satellite, and back to a ground-based detector of the ground-based device.

In Example 19, the subject matter of any of Examples 12-18, comprising: obtaining a set of physical measurements of the candidate object in addition to the physical measurement; and comparing the set of physical measurements to a set of corresponding known values.

In Example 20, the subject matter of Example 19, wherein the probability score is a composite score created based on results of comparing the set of physical measurements to the set of corresponding known values.

In Example 21, the subject matter of Example 20, wherein modifying the planned communication with the known satellite includes applying a change based on the certainty score.

In Example 22, the subject matter of Example 21, wherein the change is a security measure, the security measure being more restrictive in response to the certainty score being lower.

Example 23 is a machine readable medium including instructions for identifying an artificial satellite, the instructions, when executed by processing circuitry, cause the processing circuitry to perform operations comprising: identifying, by a ground-based device, a candidate object for a known satellite, the known satellite in an orbit; obtaining a physical measurement of the candidate object that is based on the orbit; comparing the physical measurement to a corresponding known value to generate a certainty score for whether the candidate object is the known satellite; and modifying a planned communication with the known satellite by the ground-based device based on the probability score.

In Example 24, the subject matter of Example 23, wherein the physical measurement is an orbital wobble of the candidate object.

In Example 25, the subject matter of any of Examples 23-24, wherein the physical measurement is based on a solar collector of the known satellite.

In Example 26, the subject matter of Example 25, wherein the physical measurement is a reflectivity of the solar collector that is observed from the ground-based device.

In Example 27, the subject matter of any of Examples 25-26, wherein the physical measurement is energy capture of the solar collector, the candidate object providing the energy capture as a value to the ground-based device in a handshaking procedure for the planned communication.

In Example 28, the subject matter of Example 27, wherein the corresponding known value is a pattern of energy collection over time, and wherein the value provided by the candidate object includes several samples such that the value can be compared to the pattern of energy collection overtime.

In Example 29, the subject matter of any of Examples 23-28, wherein the physical measurement is based on timing light from a ground-based emitter of the ground-based device to the known satellite, and back to a ground-based detector of the ground-based device.

In Example 30, the subject matter of any of Examples 23-29, wherein the operations comprise: obtaining a set of physical measurements of the candidate object in addition to the physical measurement; and comparing the set of physical measurements to a set of corresponding known values.

In Example 31, the subject matter of Example 30, wherein the probability score is a composite score created based on results of comparing the set of physical measurements to the set of corresponding known values.

In Example 32, the subject matter of Example 31, wherein modifying the planned communication with the known satellite includes applying a change based on the certainty score.

In Example 33, the subject matter of Example 32, wherein the change is a security measure, the security measure being more restrictive in response to the certainty score being lower.

Example 34 is a system for identifying an artificial satellite, the system comprising: means for identifying, by a ground-based device, a candidate object for a known satellite, the known satellite in an orbit; means for obtaining a physical measurement of the candidate object that is based on the orbit; means for comparing the physical measurement to a corresponding known value to generate a certainty score for whether the candidate object is the known satellite; and means for modifying a planned communication with the known satellite by the ground-based device based on the probability score.

In Example 35, the subject matter of Example 34, wherein the physical measurement is an orbital wobble of the candidate object.

In Example 36, the subject matter of any of Examples 34-35, wherein the physical measurement is based on a solar collector of the known satellite.

In Example 37, the subject matter of Example 36, wherein the physical measurement is a reflectivity of the solar collector that is observed from the ground-based device.

In Example 38, the subject matter of any of Examples 36-37, wherein the physical measurement is energy capture of the solar collector, the candidate object providing the energy capture as a value to the ground-based device in a handshaking procedure for the planned communication.

In Example 39, the subject matter of Example 38, wherein the corresponding known value is a pattern of energy collection over time, and wherein the value provided by the candidate object includes several samples such that the value can be compared to the pattern of energy collection overtime.

In Example 40, the subject matter of any of Examples 34-39, wherein the physical measurement is based on timing light from a ground-based emitter of the ground-based device to the known satellite, and back to a ground-based detector of the ground-based device.

In Example 41, the subject matter of any of Examples 34-40, comprising: means for obtaining a set of physical measurements of the candidate object in addition to the physical measurement; and means for comparing the set of physical measurements to a set of corresponding known values.

In Example 42, the subject matter of Example 41, wherein the probability score is a composite score created based on results of comparing the set of physical measurements to the set of corresponding known values.

In Example 43, the subject matter of Example 42, wherein the means for modifying the planned communication with the known satellite include means for applying a change based on the certainty score.

In Example 44, the subject matter of Example 43, wherein the change is a security measure, the security measure being more restrictive in response to the certainty score being lower.

PNUM Example 45 is at least one machine-readable medium including instructions that, when executed by processing circuitry, cause the processing circuitry to perform operations to implement of any of Examples 1-44.
PNUM Example 46 is an apparatus comprising means to implement of any of Examples 1-44.
PNUM Example 47 is a system to implement of any of Examples 1-44.
PNUM Example 48 is a method to implement of any of Examples 1-44.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. An apparatus for identifying an artificial satellite, the apparatus comprising:
memory including instructions; and
processing circuitry that, when in operation, is configured by the instructions to:
identify a candidate object for a known satellite, the known satellite in an orbit;
obtain a physical measurement of the candidate object that is based on the orbit;
compare the physical measurement to a corresponding known value to generate a certainty score for whether the candidate object is the known satellite; and
modify a planned communication with the known satellite by a ground-based device based on the probability score, wherein the apparatus is included in a ground-based device.

2. The apparatus of claim 1, wherein the physical measurement is an orbital wobble of the candidate object.

3. The apparatus of claim 1, wherein the physical measurement is based on a solar collector of the known satellite.

4. The apparatus of claim 3, wherein the physical measurement is a reflectivity of the solar collector that is observed from the ground-based device.

5. The apparatus of claim 3, wherein the physical measurement is energy capture of the solar collector, the candidate object providing the energy capture as a value to the ground-based device in a handshaking procedure for the planned communication.

6. The apparatus of claim 5, wherein the corresponding known value is a pattern of energy collection over time, and wherein the value provided by the candidate object includes several samples such that the value can be compared to the pattern of energy collection overtime.

7. The apparatus of claim 1, wherein the physical measurement is based on timing light from a ground-based emitter of the ground-based device to the known satellite, and back to a ground-based detector of the ground-based device.

8. The apparatus of claim 1, wherein the processing circuitry is configured to:
obtain a set of physical measurements of the candidate object in addition to the physical measurement; and
compare the set of physical measurements to a set of corresponding known values.

9. The apparatus of claim 8, wherein the probability score is a composite score created based on results of comparing the set of physical measurements to the set of corresponding known values.

10. A non-transitory machine readable medium including instructions for identifying an artificial satellite, the instructions, when executed by processing circuitry, cause the processing circuitry to perform operations comprising:
identifying, by a ground-based device, a candidate object for a known satellite, the known satellite in an orbit;
obtaining a physical measurement of the candidate object that is based on the orbit;
comparing the physical measurement to a corresponding known value to generate a certainty score for whether the candidate object is the known satellite; and
modifying a planned communication with the known satellite by the ground-based device based on the probability score.

11. The non-transitory machine readable medium of claim 10, wherein the physical measurement is an orbital wobble of the candidate object.

12. The non-transitory machine readable medium of claim 10, wherein the physical measurement is based on a solar collector of the known satellite.

13. The non-transitory machine readable medium of claim 12, wherein the physical measurement is a reflectivity of the solar collector that is observed from the ground-based device.

14. The non-transitory machine readable medium of claim 12, wherein the physical measurement is energy capture of the solar collector, the candidate object providing the energy capture as a value to the ground-based device in a handshaking procedure for the planned communication.

15. The non-transitory machine readable medium of claim 14, wherein the corresponding known value is a pattern of energy collection over time, and wherein the value provided by the candidate object includes several samples such that the value can be compared to the pattern of energy collection overtime.

16. The non-transitory machine readable medium of claim 10, wherein the physical measurement is based on timing light from a ground-based emitter of the ground-based device to the known satellite, and back to a ground-based detector of the ground-based device.

17. The non-transitory machine readable medium of claim 10, wherein the operations comprise:
obtaining a set of physical measurements of the candidate object in addition to the physical measurement; and
comparing the set of physical measurements to a set of corresponding known values.

18. The non-transitory machine readable medium of claim 17, wherein the probability score is a composite score created based on results of comparing the set of physical measurements to the set of corresponding known values.

19. The non-transitory machine readable medium of claim 18, wherein modifying the planned communication with the known satellite includes applying a change based on the certainty score.

20. The non-transitory machine readable medium of claim 19, wherein the change is a security measure, the security measure being more restrictive in response to the certainty score being lower.
